(19) United States
(12) Patent Application Publication
(10) Pub. No.: US 2010/0174437 A1
(43) Pub. Date: Jul. 8, 2010

(54) METHOD OF DETERMINING VEHICLE PROPERTIES

(76) Inventors: Robert Leon Benedict, Tallmadge, OH (US); Seiburn Ben Choi, Ann Arbor, MI (US); Kenneth Alan Doll, Ann Arbor, MI (US); Jon William Kindseth, Farmington, MI (US); Alan Ka Yan Lo, Sagamore Hills, OH (US); Danny Robert Milot, Ann Arbor, MI (US); Arnold Herman Spieker, Township, MI (US); Sunder Shesha Venkat Vaduri, Uniontown, OH (US); Yuhong Zheng, Ann Arbor, MI (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/094,408

(22) PCT Filed: Dec. 15, 2006
(86) PCT No.: PCT/US06/47859

§ 371 Date: Mar. 26, 2010

Related U.S. Application Data
(60) Provisional application No. 60/750,448, filed on Dec. 15, 2005.

(51) Int. Cl. G06F 7/00

(52) U.S. Cl. 701/29

(57) ABSTRACT

Vehicle properties are determined by providing both actual and real-time data of the tires to the vehicle control system. The data includes both static and dynamic tire data. The properties are determined by the following steps: a) putting a vehicle in motion, the vehicle being provided with a set of tires and a vehicle control system wherein at least one tire has means to communicate with the vehicle control system and the vehicle control system has a processor, a vehicle observer, and a preprogrammed vehicle model; b) sending either static or dynamic tire information from the tire to the vehicle control system via the tire communication means; and c) estimating a vehicle property using the received tire information.

### FIELD OF THE INVENTION

This invention relates in general to electronic stability control systems and more particularly to improving the performance of electronic stability control systems with the use of both static and dynamic tire parameters.

### BACKGROUND OF THE INVENTION

In operation, a vehicle, the tires of the vehicle, and the road upon which the vehicle travels, form a system. The mechanical characteristics of these three elements must combine to produce operating characteristics that are satisfactory to the vehicle operator. The mechanical properties of the road are preset though variable depending upon the road. The mechanical properties of the tires are determined upon production of the tire, but will vary depending upon the load, pressure, and tire wear. The response of the vehicle to the road and the tire are controlled primarily by the driver. As vehicle control systems become more sophisticated, the vehicle response to the changing driving conditions may be controlled by a greater degree by the vehicle control system rather than by the driver.

To enable the vehicle control system to respond to the changing driving conditions, it is desired to estimate the tire properties. Conventionally, a component of the vehicle control system, the vehicle observer, contains a preprogrammed model of the car and the tires. The model calculates what it believes the vehicle is doing based upon the inputs it is receiving from various sensors and the preprogrammed model of the vehicle and tires. However, if the tire model is not truly representative of the vehicle and its components, the results of the observer will not be optimum for the conditions it encounters.

### SUMMARY OF THE INVENTION

The present invention is directed to a method of providing more optimum results for a vehicle control system. More specifically, the present invention is directed towards communication of actual and real time tire data to a vehicle control system so that the system can predict a more optimum response for any given situation encountered.

In one disclosed aspect of the invention, a method of determining at least one property of a vehicle by the following steps: a) providing a vehicle with a set of tires and a vehicle control system wherein at least one tire has means to communicate with the vehicle control system and the vehicle control system has a processor and a preprogrammed vehicle model; b) sending either static or dynamic tire information from the tire to the vehicle control system via the tire communication means; and c) estimating a vehicle property by the vehicle observer using the received tire information.

In one aspect of the invention, all four tires are provided with communication means. Preferably, the communication means is an electronic tag, such as an RFID tag, embedded in the tire.

In one aspect of the invention, the tire information communicated to the vehicle control system is static data including the tire rolling radius, the cornering stiffness, the tire force and moment coefficients, the tire stiffness in the longitudinal and lateral direction, the aligning moment stiffness of the tire, and the tire size and type.

In one aspect of the invention, the tire information communicated to the vehicle control system is dynamic tire data including the instantaneous force and moment values of the tire in the longitudinal, lateral, and vertical directions, the tread wear, the tire pressure, tire temperature, and the footprint stick/slip ratio.

In another disclosed aspect of the invention, the vehicle slip angle is the desired vehicle property to be measured. The tire information sent to the vehicle control system includes the tire cornering stiffness, tire force and moment coefficients, and force and moment values in the longitudinal, lateral, and vertical directions. Using these values, the vehicle control system calculates the vehicle slip angle and responds, if necessary, to the given situation.

In another disclosed aspect of the invention, a method of determining the yaw rate target of a vehicle by the following steps: a) providing a vehicle with a set of tires and a vehicle control system wherein the vehicle control system has a processor that can calculate a yaw rate of the vehicle in motion; b) sending tire force and moment coefficient data from the tires to the vehicle control system; and c) calculating the yaw rate target using the received tire force and moment coefficients.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims.

Static tire data is a property of the tire that can be characterized after the tire has been built and includes tire characteristics and capabilities such as tire size and type, including speed ratings and load capabilities, tire rolling radius, and tire force and moment properties such as cornering stiffness. Some of this information is expressed in the tire size imprinted on the tire, e.g. P215/65R15 89H. In this tire size example, static information includes i) the tire width, 215 mm, ii) the aspect ratio of the tire, 65%, which enables calculation of the tire height, 139.75 mm, iii) the wheel diameter, 15 inches, iv) speed rating of H which indicates a maximum speed capability of 130 mph, and v) a load rating of 89 that indicates a load carry capacity of 1279 lbs.

Static tire data also includes tire stiffness as the data relates to generating vertical forces, lateral forces, and fore-aft forces. Tire sensitivities are also included in the static tire data category. Tire sensitivities are changes in the above listed tire capabilities and stiffness due to pressure, temperature and tire wear. Static tire data also includes tire force and moment coefficients for use in one of any known mathematical models of tire response, such as the Pajeka model. Static tire data can be used alone, or with other sensed data, to update tire response models that affect the tire and vehicle performance.

Dynamic tire data is a quantity that is measured as it happens and includes tread wear, tire pressure, tire temperatures, and force and moment values in the longitudinal (fore and aft; Fx), lateral (Fy), and vertical (Fz) directions. The force and moment values can be measured in at least one of three frequency sampling ranges wherein low range covers 1 to 5 Hz, medium range covers 5 to 50 Hz, and high range covers 50-1,000 Hz. Footprint stick/slip ratios are also dynamic tire properties.

As noted above, a vehicle control system (VCS) uses preprogrammed estimated tire data, as well as other vehicle condition information, to provide better vehicle control. Examples of vehicle conditions include, but are not limited to, steering wheel angle, tire pressure, tire temperatures, yaw rate target, vehicle speed, tire cornering stiffness, wheel inertia properties, as well as other criteria and conditions that can be used to more accurately measure and adjust vehicle control.

In the VCS there is both a model of the vehicle and a vehicle observer. The vehicle observer looks at the model to determine what the vehicle is and should be doing while gathering data from different sources. The more accurate the data, and the more timely the data for dynamic tire data, received by the observer, the better the vehicle controller performs in assisting in vehicle control. Herein, the term “vehicle” is being used to define the entire car platform, wherein the tires are a component of the vehicle.

Outside forces and changes to the vehicle, such as mounting a different sized tire than originally supplied, can cause the response of the VCS to no longer be as accurate as possible. As the observer runs its algorithms to control the vehicle, inaccurate data results in a less than optimal response by the vehicle observer, which results in the VCS miscalculating how the vehicle should perform. For example, the controller calculates speed based on tire rotation. But to accurately determine vehicle speed, the effective rolling radius (which is a function of tire pressure) is required. If the VCS uses only single input data, such as recommended pressure and original rolling radius, as the pressure changes, causing the effective rolling radius to change, the VCS is no longer controlling the actual situation but a hypothetical situation. Thus, the VCS may either respond prematurely or not soon enough.

In the present invention, it is a goal to provide the VCS with both actual and real time data, so that the VCS provides a more optimal response to the actual vehicle operating conditions. Actual data in regards to the tire is the static data while real time tire data is the dynamic data. One way of providing real time data to the VCS is through the RFID mounted in the tire. The table below shows a match up of both static and dynamic tire data and vehicle properties. Herein, a vehicle property is either a static or dynamic state of the vehicle or a component of the vehicle.

| | Static | | | | | Dynamic | | |
|---|---|---|---|---|---|---|---|---|
| | | Cornering | Force & moment | Long. | Size/ | Fx low | Fx med | Fx high |
| | Rolling | Stiffness | coefficients | Stiff | Type | (1-5 Hz) | (5-50 Hz) | (50-1000 Hz) |
| Robustness over the life of the tire | | | | | | | | |
| Robustness for significant vehicle changes | | | | | | | | |
| Yaw Rate Target | X | X | X | | | | | |
| Vehicle Slip Angle | | X | X | | | | | |
| Vehicle Speed (absolute) | X | | | | | | | |
| ABS/TCS impact from wheel inertia | | | | | X | | | |
| ABS sneakdown/TCS sneakup | | | | | | | X | |
| Brake gain for ABS | X | | | | X | | X | |
| Peak force/peak slip | | | X | X | | | | |
| Performance enhancements | | | | | | | | |
| Rough road detection | | | | | | | | X |
| Reverse detection/low speed detection | | | | | | | X | |
| Mill hold/grade detection | | | | | | X | | |
| Wheel slip angle control - vehicle side | | | X | | | | | |
| slip angle control | | | | | | | | |
| Lateral/long. Tire force saturation | | | X | | X | | | X |
| identification | | | | | | | | |
| Feedback for brake pressure estimates | | | | | | X | | |
| Wheel life identification | | | | | | | | |
| Tire force inputs for lead compensation | | | | | | | | X |
| relative to actuator delay | | | | | | | | |
| Mass estimation/loading | | | | | | | | |
| High frequency load information for wheel | | | | | | | | |
| input relative to roll | | | | | | | | |
| Bank bend compensation | | | | | | | | |
| Center of gravity | | | | | | | | |
| Wheel alignment estimation | | | | | | | | |
| Wheel balance estimation | | | | | | | | |
| Time pressure estimation using Fx | | | | | | X | | |

| | Dynamic | | | | | | | |
|---|---|---|---|---|---|---|---|---|
| | Fy | Fy | Fy | Fz | Fz | Fz | Tread | Footprint stick/ |
| | low | med | high | low | med | high | Wear | slip ratio |
| Robustness over the life of the tire | | | | | | | X | |
| Robustness for significant vehicle changes | | | | | | | | |
| Yaw Rate Target | | | | | | | | |
| Vehicle Slip Angle | | | X | | | X | | |
| Vehicle Speed (absolute) | | | | | | | | |
| ABS/TCS impact from wheel inertia | | | | | | | | |
| ABS sneakdown/TCS sneakup | | | | | | | | |
| Brake gain for ABS | | | | | | | | |
| Peak force/peak slip | | | | | | | | |
| Performance enhancements | | | | | | | | |
| Rough road detection | | | | | | X | | X |
| Reverse detection/low speed detection | | | | | | | | |
| Mill hold/grade detection | | | | | | | | |
| Wheel slip angle control - vehicle side | | | X | | | X | | X |
| slip angle control | | | | | | | | |
| Lateral/long. Tire force saturation | | | X | | | | | X |
| identification | | | | | | | | |
| Feedback for brake pressure estimates | | | | | | | | |
| Wheel life identification | | | | | | X | | X |
| Tire force inputs for lead compensation | | | X | | | | | |
| relative to actuator delay | | | | | | | | |
| Mass estimation/loading | | | | X | | | | |
| High frequency load information for wheel | | | X | | | X | | X |
| input relative to roll | | | | | | | | |
| Bank bend compensation | | X | | | X | | | X |
| Center of gravity | | X | | | X | | | X |
| Wheel alignment estimation | X | | | | | | | |
| Wheel balance estimation | | | X | | | X | | X |
| Time pressure estimation using Fx | | | | | | | | |

Generally, static tire data can be used as an input to control systems to provide initial control system settings (control trims). For example, data from tire sensors or tags can indicate actual static properties of a tire when the tires on a vehicle are changed. In one situation, if the size of a tire is changed, e.g. R17 to R15, then the size of the wheel has also changed. This changes the relative ride height of the vehicle. Vehicle systems, such as roll control, can account for this change in ride height by making certain assumptions based on the change in tire size.

The following are a series of examples illustrating possible utilizations of the tire data and vehicle property combinations detailed in the table.

First consider static signals (signals which do not change while a particular tire is mounted on a wheel installed on the vehicle) that might be transmitted from a tire sensor to a vehicle control system, depicted in the first five columns of the table. Regarding the first column of the table labeled “Rolling”, rolling radius can be used to calculate vehicle speed and in calculations related to vehicle speed. Vehicle speed can be calculated based upon the angular rate of the wheel/tire and the rolling radius of the tire. The calculation is based upon a translation from angular rate to linear rate. The rolling radius of the wheel/tire can change depending upon variable static and dynamic properties of different tires. The calculations can be modified or updated based upon static or dynamic data provided. The yaw rate target and the vehicle slip angle are both functions of vehicle speed. Control strategies for Enhanced Stability Control systems (ESC) generally function based upon the yaw rate target and the vehicle slip angle, and the control strategies employed by the ESC braking system can be programmed to change in dependence upon calculated vehicle speed. Increased accuracy in the calculation of vehicle speed can increase performance of the system

Regarding the column labeled “Cornering Stiffness”, an understeer coefficient can be calculated based upon cornering stiffness. The understeer coefficient can be used to determine the yaw rate target. Cornering stiffness can be used to set an initial rate in an adaptive calculation for vehicle side slip angle.

Regarding “Force and moment coefficients”, in the third column of the table, an understeer coefficient can be calculated based upon force and moment coefficients. The understeer coefficient can be used to determine the yaw rate target. Force and moment coefficients can be used to set an initial rate in an adaptive calculation for vehicle side slip angle. Additionally, force and moment coefficients can be used to determine maximum wheel slip angle to be used for side slip angle control. Further, force and moment coefficients can be used to define the maximum level of slip to provide the maximum longitudinal force that can be obtained, and the maximum level of slip angle for a maximum level of lateral force that can be obtained, thus, identifying lateral and longitudinal tire force saturation. Also, the peak force and peak slip, defined as the maximum level of slip to provide the maximum longitudinal force that can be obtained, can be obtained based in part on force and moment coefficients.

Regarding “Long. Stiff.” (Longitudinal Stiffness), the peak force and peak slip are based in part on longitudinal stiffness; longitudinal stiffness can be used as an input to a calculation estimating these values.

Regarding “Size/Type”, rolling inertia is a function of weight distribution of the tire and wheel and radius of the tire and wheel, which are characteristics of the size and type (construction) of tire. Also braking in the ABS (Antilock Braking System)/TCS (Traction Control System) may be updated with rolling inertia values calculated or estimated from the size and type of tire. Also, brake gains in brake system control algorithms, such as in ABS, TCS, and ESC brake controllers, can be adjusted for performance based upon the tire characteristics related to the size and type of tire. Additionally, lateral and longitudinal tire force saturation curves can be estimated based upon the size and type of tire. The peak values and location of the peak can be identified from these lateral and longitudinal tire force saturation curves. For example, in general a tire with a softer sidewall requires a greater slip angle to reach peak lateral force; thus, knowing that a vehicle tire is softer, we can adjust the braking system to control to a higher slip angle (during ESC (Enhanced Stability Control) braking, for example).

Now consider dynamic signals (signals generated that change over time) that might be transmitted from a tire sensor to a vehicle control system, in the remaining columns of the table. Regarding “Fx low (1-5 Hz),” a longitudinal force sensor with a low update rate, e.g. 1-5 Hz, can detect that a vehicle is stopped. Once it is known that the vehicle is stopped, the amount and direction of force acting on a tire can be used as an input to calculations to determine grade of road for hill hold functions. Also, at low frequencies periodic force activity on a wheel/tire may be used to estimate force on brake and the estimates can be compared with estimates of brake force and pressure derived from other inputs to correct the estimations in the brake pressure feedback process. Further, tire longitudinal force to slip changes as a function of tire pressure; thus, longitudinal tire force can be used as an input to calculations to determine tire pressure.

Regarding “Fx med (5-50 Hz)”, a longitudinal force sensor with a medium update rate, e.g. 5-50 Hz, can perform the same functions as a longitudinal force sensor with a low update rate (Fx low). Additionally, longitudinal tire force can be used to measure vehicle acceleration. This (vehicle acceleration) can be used to define the ABS and TCS vehicle and wheel speed references for controlling a vehicle on differing surfaces (dry pavement, wet pavement, gravel, icy surfaces, etc.). The impact of actual vehicle speed on tire forces can be compared to vehicle speed estimated from wheel speed; a difference in these values can indicate wheel slip. ABS and TCS can then be modified based on this comparison. Also, based upon a sum of longitudinal force, longitudinal acceleration of a vehicle can be estimated. This estimation can be used to optimize ABS, TCS and ESC performance (for example, by changing the amount of time that valves applying or relieving brake pressure are open). This can be performed on a single wheel/tire basis by comparing the longitudinal acceleration and braking pressure for each individual wheel/tire. Further, based upon the magnitude and direction of the longitudinal force vector the vehicle direction, e.g. forward or reverse, can be determined, especially at low speeds.

Regarding “Fx high (50-1000 Hz)”, a longitudinal force sensor with a high update rate, e.g., 50-1000 Hz, can perform the same functions as a longitudinal force sensor with a low or medium update rate. Additionally, rough road conditions can be determined based upon the frequency and magnitude of oscillations in the longitudinal tire force. Also, an accumulation of longitudinal tire force data can be used to determine peak performance relative to slip level based upon longitudinal tire force saturation. Further, when commanding an application or reduction of pressure to the brakes, there is a delay before a corresponding change in the force in the tire occurs. This delay can be measured and accounted for by initiating brake pressure commands earlier to account for this delay and get tire force to a desired value at a desired time.

Regarding “Fy low”, lateral forces sensed at a relatively low frequency can be used as an input to estimate toe-in, toe-out, camber angle, and in conjunction with forces on other tires/wheels, the (steering) alignment can be determined. Additionally, “Fy low” can be used to adjust the lateral acceleration offset.

Regarding “Fy med”, lateral tire forces sensed at a medium update rate can be used for any of the Fy low application, as well as being used for such applications as determining the presence of bank in a curve or camber in a straight piece of roadway (in conjunction with other inputs such as vehicle speed and steering angle), for example. Bank/bend compensation may be based upon this determination. Also, through the combination of lateral tire force data from all four tires, together with yaw rate, the center of gravity of the vehicle can be calculated. Center of gravity information is useful in such applications as enhanced stability control (ESC).

Regarding “Fy high”, use of a high frequency dynamic signal of lateral tire forces may be used in any of the same application as the low and medium frequency lateral tire force sensor applications, discussed above. Additionally, high frequency dynamic signals of lateral tire forces may be used in calculations similar to Force and moment coefficients; except that instead of being used to determine initial settings or trim settings, the dynamic signal of lateral tire force may be used to contemporaneously control system functions, such as those based upon vehicle slip angle, wheel slip angle, side slip angle, and tire force saturation. Additionally, the lateral force inputs can be used to enhance system performance in a manner similar to longitudinal forces to compensate actuation timing for delays in force response. Further, while negotiating a curve, the lateral force on inside tires can be compared to the lateral force on the outside tires to estimate the roll angle of a vehicle. Also, oscillations in the lateral tire forces can be used to detect a dynamic wheel imbalance condition.

Regarding “Fz low”, the low frequency normal (vertical) load forces can be summed for all the tires and divided by the gravitational constant to calculate the vehicle/load mass. This result can be used as an input to calculations in a variety of systems, including slip angle estimation and roll over detection.

Regarding “Fz med”, med frequency normal load forces can be used in any of the same application as the low frequency normal tire force sensor applications, discussed above. Additionally, medium frequency dynamic signals of normal tire forces can be used as an input to determine the presence of bank in a curve or camber in a straight piece of roadway, in conjunction with other inputs, such as Fy med, vehicle speed and steering angle, for example. Bank/bend compensation may be based upon this determination. Also, through the combination of vertical tire force data from all four tires, the location of the center of gravity can be calculated.

Regarding “Fz high”, similar to Fy high, use of a high frequency dynamic signal of normal tire load forces can be used in any of the same application as the low and medium frequency normal tire force sensor applications, discussed above. Additionally, high frequency dynamic signals of normal tire forces may be used in calculations similar to Force and moment coefficients; except that instead of being used as an estimate to determine initial settings or trim settings, the dynamic signal of vertical tire force may be used to contemporaneously control system functions, such as those based upon vehicle slip angle, wheel slip angle; side slip angle, and tire force saturation. Also, similar to Fx high, rough road conditions can be determined based upon oscillations in the normal tire load force frequency. Additionally, similar to Fx high, the normal load force inputs can be used to enhance system performance in a manner similar to longitudinal forces to compensate actuation timing for delays in force response. Further, similar to Fy high, while negotiating a curve the normal load force on inside tires can be compared to the normal load force on the outside tires to estimate the roll angle of a vehicle, and roll-over potential. Also, oscillations in the dynamic normal load tire force can be evaluated to determine a wheel balance estimation.

Regarding “Tread Wear”, a determined tread wear rate can be used to generate a notification (signal or message) of a tire or tires approaching the end of their wear life.

Regarding “Footprint stick/slip ratio”, elongation and contraction of the tire patch can, at least partially, be accounted for due to acceleration and deceleration of a tire. When the tire patch is fully in slip, any further braking will cause skidding/flat spotting. Differentiating actual stick patch area to full contact patch area can provide a measure of control available, i.e., the remaining amount of force the tire can endure before negative results occur. Oscillations in this ratio can be evaluated to determine rough road conditions. Also, similar to Fy high, tire contact patch geometry may be used in calculations similar to Force and moment coefficients; except that instead of being used to determine initial settings or trim settings, the dynamic signal of lateral tire force may be used to contemporaneously control system functions, such as those based upon vehicle slip angle, wheel slip angle, side slip angle, and tire force saturation; and while negotiating a curve the tire contact patch geometry on inside tires can be compared to the tire contact patch geometry on the outside tires to estimate the roll angle of a vehicle. Also, oscillations in the tire contact patch geometry can be evaluated to determine a wheel balance estimation. Further, similar to Fy med, bank/bend compensation may be based upon tire contact patch geometry; also, through the combination of tire contact patch geometry data from all four tires, together with yaw rate, the center of gravity can be calculated.

As noted above, the intended yaw rate target is a required control signal for the VCS. Previously, the vehicle yaw rate is controlled in the following manner. A controller initially measures a steering wheel angle to determine the intent of the driver with respect to lateral motion. Next, sensors measure the vehicle yaw rate and lateral acceleration to assess the dynamic behavior of the vehicle. The control system then actuates a wheel torque and/or powertrain drive torque control to modulate the vehicle yaw moment. Vehicle yaw stability (i.e. limited sideslip angle) helps to reduce the potential for the vehicle to leave the road and reduces the likelihood of vehicle rollover. Typically, as a vehicle approaches a sudden road obstacle, the driver rapidly changes direction causing a yaw moment to build up. As the driver turns back into the original lane, this movement leads to a yaw moment reversal that can cause the rear wheels to lose traction causing a yaw moment overshoot. This may cause the tires to lose adhesion with the road and oversteer would be induced.

Within the scope of the present invention, the desired yaw rate target of the vehicle is determined by the tire communicating the necessary data to the VCS to enable the VCS to calculate the desired yaw rate target. Per the chart above, the tire communicates the actual rolling radius, cornering stiffness and tire force and moment coefficients to the VCS. The VCS uses that data to assist with calculating what the vehicle should be doing and responds accordingly.

Another highly desired property to determine when the vehicle undergoes significant changes is the vehicle slip angle. Tire characteristics desired to calculate this value include both static and dynamic data, including the tire cornering stiffness, the tire force and moment coefficients, and the force and moment values in the longitudinal, lateral, and vertical directions. The VCS may use the actual nominal tire static data (as compared to the possible inaccurate static data preprogrammed into the vehicle model of the VCS) to calculate the vehicle slip angle. Alternatively, and preferably, the VCS uses the actual dynamic data to calculate the vehicle slip angle.

To calculate absolute vehicle speed, the actual rolling radius of the tire is transmitted to the VCS. This information, along with information about the tire rotation provided by sensors at the wheels and/or on the powertrain system, enables the VCS to determine the absolute vehicle speed.

For performance enhancement of the vehicle, it may be desired to control the wheel and vehicle side slip angle. The desired static and dynamic tire information to calculate this value includes the tire force and moment values in the longitudinal, lateral, and vertical directions and the footprint stick/slip ratio.

Another highly desired performance enhancement of the vehicle will be the lateral and longitudinal tire force saturation identification. To determine this value, the desired static and dynamic tire information is the tire lateral and longitudinal force and moment values.

As noted above, by providing updated information from the tire, the VCS may provide improved vehicular response. The tire may provide the information by means of an embedded electronic tag or sensor, preferably, an imbedded RFID sensor.

What is claimed is:

1. A method of determining at least one property of a vehicle by the following steps:
a) providing a vehicle with a set of tires and a vehicle control system wherein at least one tire has means to communicate with the vehicle control system and the vehicle control system has a processor and, a preprogrammed vehicle model;
b) sending either static or dynamic tire information from the tire to the vehicle control system via the tire communication means; and
c) estimating a vehicle property by the vehicle observer using the received tire information.

2. The method of claim 1 wherein the tire communication means is an electronic tag embedded in the tire.

3. The method of claim 1 wherein the tire communication means is a sensor that responds to the instantaneous state of the tire embedded in the tire.

4. The method of claim 1 wherein the vehicle property being estimated is the vehicle slip angle and the tire information being sent to the vehicle control system is selected from the group consisting of tire cornering stiffness, tire force and moment coefficients, and force and moment coefficients in the longitudinal, lateral, and vertical directions.

5. The method of claim 1 wherein only the dynamic tire data or only the static tire data is selected to be sent to the vehicle control system.

6. The method of claim 1 wherein the tire information being communicated to the vehicle control system is the tire force and moment coefficients for the at least one tire.

7. The method of claim 1 wherein the vehicle is provided with four tires and all four tires communicate, via the communication means, tire force and moment coefficients for each tire to the vehicle control system.

8. The method of claim 1 wherein the tire information being communicated to the vehicle control system are force and moment values in at least one direction selected from the group consisting of longitudinal, vertical, and lateral direction.

9. A method of determining the yaw rate target of a vehicle by the following steps:
a) the vehicle being provided with a set of tires and a vehicle control system wherein the vehicle control system has a processor that can calculate a yaw rate target of the vehicle in motion,
b) sending tire force and moment coefficient data from the tires to the vehicle control system, and
c) calculating the yaw rate target using the received tire force and moment coefficients.
